(19) United States
(12) Patent Application Publication
(10) Pub. No.: US 2026/0066190 A1
(43) Pub. Date: Mar. 5, 2026

(54) Solid Electrolytic Capacitor

(71) Applicant: KYOCERA AVX Components Corporation, Fountain Inn, SC (US)

(72) Inventors: Pavel Koci, Ceska Trebova (CZ); Krystof Adamek, Ostrov (CZ); Jan Petrzilek, Usti nad Orlici (CZ)

(21) Appl. No.: 19/291,845

(22) Filed: Aug. 6, 2025

Related U.S. Application Data
(60) Provisional application No. 63/688,333, filed on Aug. 29, 2024.

(51) Int. Cl. H01G 9/028; H01G 9/012; H01G 9/04; H01G 9/052; H01G 9/10; H01G 9/15

(52) U.S. Cl. CPC H01G 9/028; H01G 9/012; H01G 9/0525; H01G 9/10; H01G 9/15; H01G 2009/05

(57) ABSTRACT

A solid electrolytic capacitor containing a porous anode and a solid electrolyte is provided. The porous anode is formed from a sintered valve metal powder that is anodically oxidized to form a dielectric layer thereon having a dielectric thickness of about 70 nm or more, wherein the porous anode has a pore size distribution in which the pores have a size of from about 165 to about 270 nm at a pore volume corresponding to at least 80% of the total pore volume and exhibits a volumetric wet capacitance of about 3,900 μF/cm³ or more. The solid electrolyte contains conductive polymer particles that are disposed within the pores of the porous anode. Further, the solid electrolytic capacitor exhibits a dielectric strength of about 0.6 V/nm or more.

### RELATED APPLICATION

The present application is based upon and claims priority to U.S. Provisional Patent Application Ser. No. 63/688,333, having a filing date of Aug. 29, 2024, which is incorporated herein by reference.

### BACKGROUND OF THE INVENTION

High voltage solid electrolytic capacitors (e.g., tantalum capacitors) are typically made by pressing a valve metal powder (e.g., tantalum) around a metal lead wire to form a porous anode, sintering the anode, anodically oxidizing the anode to form a dielectric coating thereon, and thereafter impregnating a dispersion of conductive polymer particles into the porous anode. To achieve a higher degree of capacitance for these capacitors, high capacitance powders may be employed that are formed from particles having a nano-scale size, which results in the formation of very small pores between the particles. Unfortunately, it can be difficult to form the thicker dielectric layers required for high voltage applications and/or to readily impregnate conventional conductive polymer particle dispersions into these small pores. As such, a need currently exists for a solid electrolytic capacitor that has a high degree of capacitance but can still be used in high voltage applications.

### SUMMARY OF THE INVENTION

In accordance with one embodiment of the present invention, a solid electrolytic capacitor is disclosed that comprises a porous anode and a solid electrolyte. The porous anode is formed from a sintered valve metal powder that is anodically oxidized to form a dielectric layer thereon having a dielectric thickness of about 70 nm or more, wherein the porous anode has a pore size distribution in which the pores have a size of from about 165 to about 270 nm at a pore volume corresponding to at least 80% of the total pore volume and exhibits a volumetric wet capacitance of about 3,900 μF/cm³ or more. The solid electrolyte contains conductive polymer particles that are disposed within the pores of the porous anode. Further, the solid electrolytic capacitor exhibits a dielectric strength of about 0.6 V/nm or more.

Other features and aspects of the present invention are set forth in greater detail below.

### BRIEF DESCRIPTION OF THE DRAWING

A full and enabling disclosure of the present invention, including the best mode thereof, directed to one of ordinary skill in the art, is set forth more particularly in the remainder of the specification, which makes reference to the appended FIGURE in which:

FIG. 1 is a cross-sectional view of one embodiment of a capacitor of the present invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention, which broader aspects are embodied in the exemplary construction.

Generally speaking, the present invention is directed to a solid electrolytic capacitor that includes a porous anode formed from a sintered valve metal powder that is anodically oxidized to form a dielectric layer thereon. Further, a solid electrolyte overlies the dielectric. The solid electrolyte contains conductive polymer particles (e.g., in one or more inner layer(s) that are disposed within the pores of the anode. Without intending to be limited by theory, the present inventors have discovered that through selective control over the porosity of the anode, the resulting capacitor can achieve a high degree of capacitance without adversely impacting the ability to form a thick dielectric layer or the ability of the conductive polymer particles to penetrate into the pores of the anode.

More particularly, the porosity of the anode may, for example, have a narrow and controlled distribution in which the pores have a size of about 165 to about 270 nanometers (“nm”), in some embodiments about 170 to about 260 nm, and in some embodiments, from about 180 to about 250 nm at a pore volume corresponding to at least 80% of the total pore volume (“D80” size). In certain embodiments, the pores have a size of from about 130 to about 190 nm, in some embodiments about 135 to about 185 nm, and in some embodiments, from about 140 to about 180 nm at a pore volume corresponding to at least 90% of the total pore volume (“D90” size). The pores may also have a size of from about 100 nm to about 475 nm, in some embodiments from about 150 nm to about 450 nm, and in some embodiments, from about 200 nm to about 350 nm at a pore volume corresponding to at least 50% of the total pore volume (“D50” size). While the pore size distribution may be unimodal or multi-modal, a primarily unimodal distribution is typically desired.

The resulting anode may thus exhibit a high volumetric wet capacitance (wet capacitance divided by total anode volume obtained after sintering), such as about 3,900 Microfarads per cubic centimeter (μF/cm³) or more, in some embodiments about 4,000 μF/cm³ or more, in some embodiments about 4,100 μF/cm³ or more, and in some embodiments, from about 4,200 to about 5,000 μF/cm³. While these values may vary based on the size of the capacitor, the wet capacitance is typically about 20 μF or more, in some embodiments about 35 μF or more, and in some embodiments about 60 μF to about 200 μF, and the total anode volume is typically about 0.005 cm³ or more, in some embodiments about 0.008 cm³ or more, and in some embodiments, from about 0.01 to about 0.03 cm³.

Even at such high volumetric wet capacitance values, thick dielectric layers can still be readily formed, such as about 70 nanometers or more, in some embodiments from about 80 to about 400 nm, in some embodiments from about 90 to about 300 nm, and in some embodiments, from about 100 to about 200 nm. Furthermore, the conductive polymer particles of the solid electrolyte can also be readily impregnated into the pores of the anode. This may lead to an improved “dielectric strength”, which generally refers to the ratio of the “breakdown voltage” of the capacitor (voltage at which the capacitor fails in volts, “V”) to the thickness of the dielectric (in nanometers, “nm”). For example, the capacitor typically exhibits a dielectric strength of about 0.6 V/nm or more, in some embodiments about 0.65 V/nm or more, in some embodiments about 0.7 V/nm or more, in some embodiments from about 0.7 to about 1 V/nm, and in some embodiments, from about 0.75 to about 0.9 V/nm. The breakdown voltage may, for example, be about 50 V or more, in some embodiments about 55 V or more, in some embodiments about 60 V or more, in some embodiments about 65 volts or more, in some embodiments about 70 V or more, in some embodiments about 80 V or more, and in some embodiments, from about 80 to about 150 V.

Various embodiments of the invention will now be described in more detail.

i. Anode

As noted above, the anode includes an anode body formed from a valve metal powder that contains a valve metal (e.g., tantalum) or valve metal-based compound (e.g., niobium monoxide). In one embodiment, for instance, the valve metal powder is formed from tantalum. If desired, a reduction process may be employed in which a tantalum salt (e.g., potassium fluorotantalate (K₂TaF₇), sodium fluorotantalate (Na₂TaF₇), tantalum pentachloride (TaCl₅), etc.) is reacted with a reducing agent. The reducing agent may be provided in the form of a liquid, gas (e.g., hydrogen), or solid, such as a metal (e.g., sodium), metal alloy, or metal salt. In one embodiment, for instance, a tantalum salt (e.g., TaCl₅) may be heated at a temperature of from about 900° C. to about 2,000° C., in some embodiments from about 1,000° C. to about 1,800° C., and in some embodiments, from about 1,100° C. to about 1,600° C., to form a vapor that can be reduced in the presence of a gaseous reducing agent (e.g., hydrogen). Additional details of such a reduction reaction may be described in WO 2014/199480 to Maeshima, et al. After the reduction, the product may be cooled, crushed, and washed to form a powder.

The powder may be a free-flowing, finely divided powder that contains primary particles. The primary particles of the powder generally have a median size (D50) of from about 5 to about 250 nanometers, in some embodiments from about 10 to about 200 nanometers, and in some embodiments, from about 20 to about 150 nanometers, such as determined using a laser particle size distribution analyzer made by BECKMAN COULTER Corporation (e.g., LS-230), optionally after subjecting the particles to an ultrasonic wave vibration of 70 seconds. The primary particles typically have a three-dimensional granular shape (e.g., nodular or angular). Such particles typically have a relatively low “aspect ratio”, which is the average diameter or width of the particles divided by the average thickness (“D/T”). For example, the aspect ratio of the particles may be about 4 or less, in some embodiments about 3 or less, and in some embodiments, from about 1 to about 2. In addition to primary particles, the powder may also contain other types of particles, such as secondary particles formed by aggregating (or agglomerating) the primary particles. Such secondary particles may have a median size (D50) of from about 1 to about 500 micrometers, and in some embodiments, from about 10 to about 250 micrometers. The valve metal powder may have a relatively high specific charge, such as about 50,000 μF*V/g or more, in some embodiments from about 50,000 to about 350,000 μF*V/g, in some embodiments from about 51,000 to about 200,000 μF*V/g, and in some embodiments, from about 52,000 to about 100,000 μF*V/g. The specific charge may be determined by multiplying capacitance by the anodizing voltage employed, and then dividing this product by the weight of the anodized electrode body.

Agglomeration of the particles may occur by heating the particles and/or through the use of a binder. For example, agglomeration may occur at a temperature of from about 0° C. to about 40° C., in some embodiments from about 5° C. to about 35° C., and in some embodiments, from about 15° C. to about 30° C. Suitable binders may likewise include, for instance, poly(vinyl butyral); poly(vinyl acetate); poly(vinyl alcohol); poly(vinyl pyrrolidone); cellulosic polymers, such as carboxymethylcellulose, methyl cellulose, ethyl cellulose, hydroxyethyl cellulose, and methylhydroxyethyl cellulose; atactic polypropylene, polyethylene; polyethylene glycol (e.g., Carbowax from Dow Chemical Co.); polystyrene, poly(butadiene/styrene); polyamides, polyimides, and polyacrylamides, high molecular weight polyethers; copolymers of ethylene oxide and propylene oxide; fluoropolymers, such as polytetrafluoroethylene, polyvinylidene fluoride, and fluoro-olefin copolymers; acrylic polymers, such as sodium polyacrylate, poly(lower alkyl acrylates), poly(lower alkyl methacrylates) and copolymers of lower alkyl acrylates and methacrylates; and fatty acids and waxes, such as stearic and other soapy fatty acids, vegetable wax, microwaxes (purified paraffins), etc. If desired, the powder may also be doped with sinter retardants in the presence of a dopant, such as aqueous acids (e.g., phosphoric acid). The amount of the dopant added depends in part on the surface area of the powder, but is typically present in an amount of no more than about 200 parts per million (“ppm”). The dopant may be added prior to, during, and/or subsequent to agglomeration. The powder may also be subjected to one or more deoxidation treatments. For example, the powder may be exposed to a getter material (e.g., magnesium), such as described in U.S. Pat. No. 4,960,471. The temperature at which deoxidation of the powder occurs may vary, but typically ranges from about 700° C. to about 1,600° C., in some embodiments from about 750° C. to about 1,200° C., and in some embodiments, from about 800° C. to about 1,000° C. The total time of the deoxidation treatment(s) may range from about 20 minutes to about 3 hours.

The resulting powder may have certain characteristics that enhance its ability to be used in a capacitor anode. For example, the powder typically has a specific surface area of from about 0.5 to about 10.0 m²/g, in some embodiments from about 0.7 to about 5.0 m²/g, and in some embodiments, from about 2.0 to about 4.0 m²/g. Likewise, the bulk density of the powder may be from about 0.1 to about 0.8 grams per cubic centimeter (g/cm³), in some embodiments from about 0.2 to about 0.6 g/cm³, and in some embodiments, from about 0.4 to about 0.6 g/cm³.

Once the powder is formed, it is then generally compacted or pressed to form a pellet using any conventional powder press device. For example, a press mold may be employed that is a single station compaction press containing a die and one or multiple punches. Alternatively, anvil-type compaction press molds may be used that use only a die and single lower punch. Single station compaction press molds are available in several basic types, such as cam, toggle/knuckle and eccentric/crank presses with varying capabilities, such as single action, double action, floating die, movable platen, opposed ram, screw, impact, hot pressing, coining or sizing. The powder is typically pressed to a density of from about 0.5 to about 20 g/cm³, in some embodiments from about 1 to about 15 g/cm³, and in some embodiments, from about 2 to about 10 g/cm³. The powder may be compacted around an anode lead, which may be in the form of a wire, sheet, etc. The lead may extend in a longitudinal direction from the anode body and may be formed from any electrically conductive material, such as tantalum, niobium, aluminum, hafnium, titanium, etc., as well as electrically conductive oxides and/or nitrides of thereof. Connection of the lead may also be accomplished using other known techniques, such as by welding the lead to the body or embedding it within the anode body during formation (e.g., prior to compaction and/or sintering). Any binder may be removed after pressing by heating the pellet under vacuum at a certain temperature (e.g., from about 150° C. to about 500° C.) for several minutes. Alternatively, the binder may also be removed by contacting the pellet with an aqueous solution, such as described in U.S. Pat. No. 6,197,252 to Bishop, et al.

After binder removal, the anode body may optionally be subjected to a deoxidation process. In one embodiment, for example, the deoxidation process includes exposing the anode body to a getter material (e.g., magnesium, titanium, etc.) that is capable of removing oxygen from the anode body by chemical reaction, adsorption, etc. More particularly, the anode body is initially inserted into an enclosure (e.g., tantalum box) that also contains the getter material. The atmosphere within the enclosure is typically an inert atmosphere (e.g., argon gas). To initiate the deoxidation, the atmosphere within the enclosure is heated to a temperature that is sufficient to melt and/or vaporize the getter material and deoxidize the anode body. The temperature may vary depending on the specific charge of the anode powder, but typically ranges from about 700° C. to about 1,200° C., in some embodiments from about 750° C. to about 1,100° C., and in some embodiments, from about 800° C. to about 1,000° C. The total time of deoxidation may range from about 20 minutes to about 3 hours. This may occur in one or more steps. Upon completion of the deoxidation, the getter material typically vaporizes and forms a precipitate on a wall of the enclosure. To ensure removal of the getter material, the anode body may also be subjected to one or more acid leaching steps, such as with a solution of nitric acid, hydrofluoric acid, hydrogen peroxide, sulfuric acid, water, etc., or a combination thereof.

After optional deoxidation, the anode body may be sintered to form a porous, integral mass. The anode body is typically sintered at a temperature of from about 700° C. to about 1,600° C., in some embodiments from about 800° C. to about 1,500° C., and in some embodiments, from about 900° C. to about 1,200° C., for a time of from about 5 minutes to about 100 minutes, and in some embodiments, from about 8 minutes to about 15 minutes. This may occur in one or more steps. If desired, sintering may occur in an atmosphere that limits the transfer of oxygen atoms to the anode. For example, sintering may occur in a reducing atmosphere, such as in a vacuum, inert gas, hydrogen, etc. The reducing atmosphere may be at a pressure of from about 10 Torr to about 2000 Torr, in some embodiments from about 100 Torr to about 1000 Torr, and in some embodiments, from about 100 Torr to about 930 Torr. Mixtures of hydrogen and other gases (e.g., argon or nitrogen) may also be employed. As noted above, sintering of the anode body generally occurs after any optional deoxidation. It should be understood, however, that the anode body may also be subjected to one or more pre-sintering steps prior to oxidation to help provide the desired degree of green strength for the deoxidation process. Such pre-sintering steps may be conducted under the same or different conditions as the sintering process that occurs after deoxidation. For example, pre-sintering may occur in one or more steps at a temperature of from about 700° C. to about 1,600° C., in some embodiments from about 800° C. to about 1,500° C., and in some embodiments, from about 900° C. to about 1,200° C., for a time of from about 5 minutes to about 100 minutes, and in some embodiments, from about 8 minutes to about 15 minutes. Pre-sintering may also occur in a reducing atmosphere, such as in a vacuum, inert gas, hydrogen, etc., as described above.

As noted above, the sintered anode body is anodically oxidized so that a dielectric layer is formed over and/or within the anode body. For example, a tantalum (Ta) anode may be anodized to tantalum pentoxide (Ta₂O₅). Typically, anodization is performed by initially applying a solution to the anode, such as by dipping anode into the electrolyte. A solvent is generally employed, such as water (e.g., deionized water). To enhance ionic conductivity, a compound may be employed that is capable of dissociating in the solvent to form ions. Examples of such compounds include, for instance, acids, such as described below with respect to the electrolyte. For example, an acid (e.g., phosphoric acid) may constitute from about 0.01 wt. % to about 5 wt. %, in some embodiments from about 0.05 wt. % to about 0.8 wt. %, and in some embodiments, from about 0.1 wt. % to about 0.5 wt. % of the anodizing solution. If desired, blends of acids may also be employed.

A current may be passed through the anodizing solution to form the dielectric layer. The value of the formation voltage manages the thickness of the dielectric layer. For example, the power supply may be initially set up at a galvanostatic mode until the required voltage is reached. Thereafter, the power supply may be switched to a potentiostatic mode to ensure that the desired dielectric thickness is formed over the entire surface of the anode. Of course, other known methods may also be employed, such as pulse or step potentiostatic methods. The forming voltage employed during anodization is generally about 20 volts or more, in some embodiments about 30 volts or more, in some embodiments about 35 volts or more, and in some embodiments, from about 35 to about 70 volts, and at temperatures ranging from about 10° C. or more, in some embodiments from about 20° C. to about 200° C., and in some embodiments, from about 30° C. to about 100° C. The resulting dielectric layer may be formed on a surface of the anode and within its pores.

Although by no means required, a pre-coat layer may optionally overly the dielectric that includes an organometallic compound. The organometallic compound may have the following general formula:

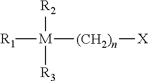

wherein,
M is an organometallic atom, such as silicon, titanium, and so forth;
R₁, R₂, and R₃ are independently an alkyl (e.g., methyl, ethyl, propyl, etc.) or a hydroxyalkyl (e.g., hydroxymethyl, hydroxyethyl, hydroxypropyl, etc.), wherein at least one of R₁, R₂, and R₃ is a hydroxyalkyl;
n is an integer from 0 to 8, in some embodiments from 1 to 6, and in some embodiments, from 2 to 4 (e.g., 3); and
X is an organic or inorganic functional group, such as glycidyl, glycidyloxy, mercapto, amino, vinyl, etc.

In certain embodiments, R₁, R₂, and R₃ may a hydroxyalkyl (e.g., OCH₃). In other embodiments, however, R₁ may be an alkyl (e.g., CH₃) and R₂ and R₃ may a hydroxyalkyl (e.g., OCH₃).

Further, in certain embodiments, M may be silicon so that the organometallic compound is an organosilane compound, such as an alkoxysilane. Suitable alkoxysilanes may include, for instance, 3-aminopropyltrimethoxysilane, 3-aminopropyltriethoxysilane, 3-aminopropylmethyldimethoxysilane, 3-aminopropylmethyldiethoxysilane, 3-(2-aminoethyl)aminopropyltrimethoxysilane, 3-mercaptopropyltrimethoxysilane, 3-mercaptopropyltriethoxysilane, 3-mercaptopropylmethyldimethoxysilane, 3-mercaptopropylmethyldiethoxysilane, glycidoxymethyltrimethoxysilane, glycidoxymethyltriethoxysilane, glycidoxymethyl-tripropoxysilane, glycidoxymethyltributoxysilane, β-glycidoxyethyltrimethoxysilane, β-glycidoxyethyltriethoxysilane, β-glycidoxyethyl-tripropoxysilane, β-glycidoxyethyl-tributoxysilane, β-glycidoxyethyltrimethoxysilane, α-glycidoxyethyltriethoxysilane, α-glycidoxyethyltripropoxysilane, α-glycidoxyethyltributoxysilane, γ-glycidoxypropyl-trimethoxysilane, γ-glycidoxypropyltriethoxysilane, γ-glycidoxypropyl-tripropoxysilane, γ-glycidoxypropyltributoxysilane, β-glycidoxypropyltrimethoxysilane, β-glycidoxypropyl-triethoxysilane, β-glycidoxypropyltripropoxysilane, α-glycidoxypropyltributoxysilane, α-glycidoxypropyltrimethoxysilane, α-glycidoxypropyltriethoxysilane, α-glycidoxypropyl-tripropoxysilane, α-glycidoxypropyltributoxysilane, γ-glycidoxybutyltrimethoxysilane, δ-glycidoxybutyltriethoxysilane, δ-glycidoxybutyltripropoxysilane, δ-glycidoxybutyl-tributoxysilane, δ-glycidoxybutyltrimethoxysilane, γ-glycidoxybutyltriethoxysilane, γ-glycidoxybutyltripropoxysilane, γ-propoxybutyltributoxysilane, δ-glycidoxybutyl-trimethoxysilane, δ-glycidoxybutyltriethoxysilane, δ-glycidoxybutyltripropoxysilane, α-glycidoxybutyltrimethoxysilane, α-glycidoxybutyltriethoxysilane, α-glycidoxybutyl-tripropoxysilane, α-glycidoxybutyltributoxysilane, (3,4-epoxycyclohexyl)-methyl-trimethoxysilane, (3,4-epoxycyclohexyl)methyl-triethoxysilane, (3,4-epoxycyclohexyl)methyltripropoxysilane, (3,4-epoxycyclohexyl)-methyl-tributoxysilane, (3,4-epoxycyclohexyl)ethyl-trimethoxysilane, (3,4-epoxycyclohexyl)ethyl-triethoxysilane, (3,4-epoxycyclohexyl)ethyltripropoxysilane, (3,4-epoxycyclohexyl)ethyltributoxysilane, (3,4-epoxycyclohexyl)propyltrimethoxysilane, (3,4-epoxycyclohexyl)propyltriethoxysilane, (3,4-epoxycyclohexyl)propyl-tripropoxysilane, (3,4-epoxycyclohexyl)propyltributoxysilane, (3,4-epoxycyclohexyl)butyltrimethoxysilane, (3,4-epoxycyclohexy) butyltriethoxysilane, (3,4-epoxycyclohexyl)butyltripropoxysilane, (3,4-epoxycyclohexyl)butyltributoxysilane, and so forth.

The particular manner in which the pre-coat layer is applied to the anode may vary as desired. In one particular embodiment, the compound is dissolved in an organic solvent and applied to the part as a solution, such as by screen-printing, dipping, electrophoretic coating, spraying, etc. The organic solvent may vary, but is typically an alcohol, such as methanol, ethanol, etc. Organometallic compounds may constitute from about 0.1 wt. % to about 10 wt. %, in some embodiments from about 0.2 wt. % to about 8 wt. %, and in some embodiments, from about 0.5 wt. % to about 5 wt. % of the solution. Solvents may likewise constitute from about 90 wt. % to about 99.9 wt. %, in some embodiments from about 92 wt. % to about 99.8 wt. %, and in some embodiments, from about 95 wt. % to about 99.5 wt. % of the solution. Once applied, the part may then be dried to remove the solvent therefrom and form a pre-coat layer containing the organometallic compound.

### II. Solid Electrolyte

As indicated above, a solid electrolyte overlies the dielectric of the anode (including any optional pre-coat). The total thickness of the solid electrolyte is typically from about 1 to about 50 μm, and in some embodiments, from about 5 to about 20 μm. The solid electrolyte generally contains conductive polymer particles that are disposed within the pores of the anode. The conductive polymer particles may contain a conductive polymer (e.g., polyheterocycles, such as polypyrroles, polythiophenes, polyanilines, etc., polyacetylenes, poly-p-phenylenes, polyphenolates, etc.), and so forth. Thiophene polymers are particularly suitable for use in the solid electrolyte. In certain embodiments, for instance, a thiophene polymer may be employed that has repeating units of the following formula (I):

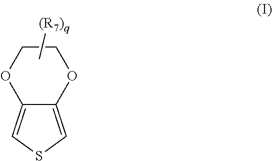

wherein,
R₇ is a linear or branched, C₁ to C₁₈ alkyl radical (e.g., methyl, ethyl, n- or iso-propyl, n-, iso-, sec- or tert-butyl, n-pentyl, 1-methylbutyl, 2-methylbutyl, 3-methylbutyl, 1-ethylpropyl, 1,1-dimethylpropyl, 1,2-dimethylpropyl, 2,2-dimethylpropyl, n-hexyl, n-heptyl, n-octyl, 2-ethylhexyl, n-nonyl, n-decyl, n-undecyl, n-dodecyl, n-tridecyl, n-tetradecyl, n-hexadecyl, n-octadecyl, etc.); C₅ to C₁₂ cycloalkyl radical (e.g., cyclopentyl, cyclohexyl, cycloheptyl, cyclooctyl, cyclononyl, cyclodecyl, etc.); C₆ to C₁₄ aryl radical (e.g., phenyl, naphthyl, etc.); C₇ to C₁₈ aralkyl radical (e.g., benzyl, o-, m-, p-tolyl, 2,3-, 2,4-, 2,5-, 2-6, 3-4-, 3,5-xylyl, mesityl, etc.); and
q is an integer from 0 to 8, in some embodiments, from 0 to 2, and in one embodiment, 0.

Particularly suitable thiophene polymers are those in which “D” is an optionally substituted C₂ to C₃ alkylene radical. For instance, the polymer may be optionally substituted poly(3,4-ethylenedioxythiophene), which has repeating units of the following general formula (II):

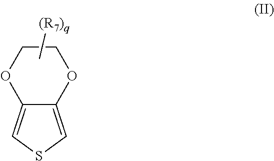

In one particular embodiment, “q” is 0. One commercially suitable example of 3,4-ethylenedioxthiophene is available from Heraeus under the designation Clevios™ M. Other suitable monomers are also described in U.S. Pat. No. 5,111,327 to Blohm, et al. and 6,635,729 to Groenendaal, et al. Derivatives of these monomers may also be employed that are, for example, dimers or trimers of the above monomers. Higher molecular derivatives, i.e., tetramers, pentamers, etc. of the monomers are suitable for use in the present invention. The derivatives may be made up of identical or different monomer units and used in pure form and in a mixture with one another and/or with the monomers. Oxidized or reduced forms of these precursors may also be employed.

To form the polymer, the precursor monomer may be polymerized in the presence of an oxidative catalyst (e.g., chemically polymerized). The oxidative catalyst typically includes a transition metal cation, such as iron(III), copper(II), chromium(VI), cerium(IV), manganese(IV), manganese(VII), or ruthenium(III) cations, and etc. A dopant may also be employed to provide excess charge to the conductive polymer and stabilize the conductivity of the polymer. The dopant typically includes an inorganic or organic anion, such as an ion of a sulfonic acid (e.g., p-toluene sulfonate). In certain embodiments, the oxidative catalyst has both a catalytic and doping functionality in that it includes a cation (e.g., transition metal) and an anion (e.g., sulfonic acid). For example, the oxidative catalyst may be a transition metal salt that includes iron(III) cations, such as iron(III) halides (e.g., FeCl₃) or iron(III) salts of other inorganic acids, such as Fe(ClO₄)₃ or Fe₂(SO₄)₃ and the iron(III) salts of organic acids and inorganic acids comprising organic radicals. Examples of iron (III) salts of inorganic acids with organic radicals include, for instance, iron(III) salts of sulfuric acid monoesters of C₁ to C₂₀ alkanols (e.g., iron(III) salt of lauryl sulfate). Likewise, examples of iron(III) salts of organic acids include, for instance, iron(III) salts of C₁ to C₂₀ alkane sulfonic acids (e.g., methane, ethane, propane, butane, or dodecane sulfonic acid); iron (III) salts of aliphatic perfluorosulfonic acids (e.g., trifluoromethane sulfonic acid, perfluorobutane sulfonic acid, or perfluorooctane sulfonic acid); iron (III) salts of aliphatic C₁ to C₂₀ carboxylic acids (e.g., 2-ethylhexylcarboxylic acid); iron (III) salts of aliphatic perfluorocarboxylic acids (e.g., trifluoroacetic acid or perfluorooctane acid); iron (III) salts of aromatic sulfonic acids optionally substituted by C₁ to C₂₀ alkyl groups (e.g., benzene sulfonic acid, o-toluene sulfonic acid, p-toluene sulfonic acid, or dodecylbenzene sulfonic acid); iron (III) salts of cycloalkane sulfonic acids (e.g., camphor sulfonic acid); and so forth. Mixtures of these above-mentioned iron(III) salts may also be used. Iron(III)-p-toluene sulfonate, iron(III)-o-toluene sulfonate, and mixtures thereof, are particularly suitable. One commercially suitable example of iron(III)-p-toluene sulfonate is available from Heraeus under the designation Clevios™ C.

Typically, the conductive polymer particles are “pre-polymerized” in a manner such as described above prior to application to the anode. In one embodiment, for example, the pre-polymerized polymer is an intrinsically conductive polymer that has a positive charge located on the main chain that is at least partially compensated by anions covalently bound to the polymer. Such polymers may, for example, have a relatively high specific conductivity, in the dry state, of about 1 Siemen per centimeter (“S/cm”) or more, in some embodiments about 10 S/cm or more, in some embodiments about 25 S/cm or more, in some embodiments about 40 S/cm or more, and in some embodiments, from about 50 to about 500 S/cm. One example of a suitable intrinsically conductive thiophene polymer may have repeating units of the following formula (III):

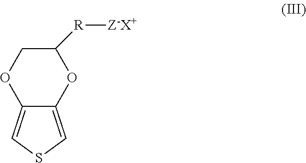

wherein,
R is (CH₂)ₐ—O—(CH₂)_{b}-L, where L is a bond or HC([CH₂]_{c}H);
a is from 0 to 10, in some embodiments from 0 to 6, and in some embodiments, from 1 to 4 (e.g., 1);
b is from 1 to 18, in some embodiments from 1 to 10, and in some embodiments, from 2 to 6 (e.g., 2, 3, 4, or 5);
c is from 0 to 10, in some embodiments from 0 to 6, and in some embodiments, from 1 to 4 (e.g., 1);
Z is an anion, such as SO₃⁻, C(O)O⁻, BF₄⁻, CF₃SO₃⁻, SbF₆⁻, N(SO₂CF₃)₂⁻, C₄H₃O₄⁻, ClO₄⁻, etc.;
X is a cation, such as hydrogen, an alkali metal (e.g., lithium, sodium, rubidium, cesium or potassium), ammonium, etc.

In one particular embodiment, Z in formula (III) is a sulfonate ion such that the intrinsically conductive polymer contains repeating units of the following formula (IV):

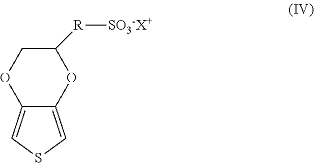

wherein, R and X are defined above. In formula (III) or (IV), a is preferably 1 and b is preferably 3 or 4. Likewise, X is preferably sodium or potassium.

If desired, the polymer may be a copolymer that contains other types of repeating units. In such embodiments, the repeating units of formula (III) typically constitute about 50 mol. % or more, in some embodiments from about 75 mol. % to about 99 mol. %, and in some embodiments, from about 85 mol. % to about 95 mol. % of the total amount of repeating units in the copolymer. Of course, the polymer may also be a homopolymer to the extent that it contains 100 mol. % of the repeating units of formula (ill). Specific examples of such homopolymers include poly(4-(2,3-dihydrothieno-[3,4-b][1,4]dioxin-2-ylmethoxy)-1-butane-sulphonic acid, salt) and poly(4-(2,3-dihydrothieno-[3,4-b][1,4]dioxin-2-ylmethoxy)-1-propanesulphonic acid, salt).

In another embodiment, the intrinsically conductive polymer has repeating thiophene units of the following general formula (V):

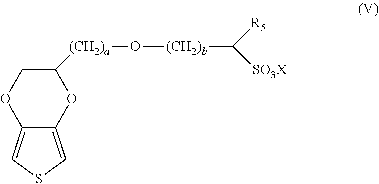

wherein,
a and b are as defined above;
R₅ is an optionally substituted C₁-C₆ linear or branched alkyl group (e.g., methyl) or a halogen atom (e.g., fluorine);
X is a hydrogen atom, an alkali metal (e.g., Li, Na, or K), NH(R¹)₃, or HNC₅H₅, wherein R¹ is each independently a hydrogen atom or an optionally substituted C₁-C₆ alkyl group.

Specific examples of thiophene compounds used to form such repeating are described in U.S. Pat. No. 9,718,905 and may include, for instance, sodium 3-[(2,3-dihydrothieno[3,4-b][1,4]dioxin-2-yl)methoxy]-1-methyl-1-propanesulfonate, sodium 3-[(2,3-dihydrothieno[3,4-b]-[1,4]dioxin-2-yl)methoxy]-1-ethyl-1-propanesulfonate, sodium 3-[(2,3-dihydrothieno[3,4-b]-[1,4]dioxin-2-yl)methoxy]-1-propyl-1-propane-sulfonate, sodium 3-[(2,3-dihydrothieno[3,4-b]-[1,4]dioxin-2-yl)methoxy]-1-butyl-1-propanesulfonate, sodium 3-[(2,3-dihydrothieno[3,4-b]-[1,4]dioxin-2-yl)methoxy]-1-pentyl-1-propane-sulfonate, sodium 3-[(2,3-dihydrothieno[3,4-b]-[1,4]dioxin-2-yl)methoxy]-1-hexyl-1-propanesulfonate, sodium 3-[(2,3-dihydrothieno[3,4-b]-[1,4]dioxin-2-yl)methoxy]-1-isopropyl-1-propanesulfonate, sodium 3-[(2,3-dihydrothieno[3,4-b]-[1,4]dioxin-2-yl)methoxy]-1-isobutyl-1-propanesulfonate, sodium 3-[(2,3-dihydrothieno[3,4-b]-[1,4]dioxin-2-yl)methoxy]-1-isopentyl-1-propanesulfonate, sodium 3-[(2,3-dihydrothieno[3,4-b]-[1,4]dioxin-2-yl)methoxy]-1-fluoro-1-propanesulfonate, potassium 3-[(2,3-dihydrothieno[3,4-b]-[1,4]dioxin-2-yl)methoxy]-1-methyl-1-propanesulfonate, 3-[(2,3-dihydrothieno[3,4-b]-[1,4]dioxin-2-yl)methoxy]-1-methyl-1-propanesulfonic acid, ammonium 3-[(2,3-dihydrothieno[3,4-b]-[1,4]dioxin-2-yl)methoxy]-1-methyl-1-propane-sulfonate, triethylammonium 3-[(2,3-dihydrothieno[3,4-b]-[1,4]dioxin-2-yl)methoxy]-1-methyl-1-propanesulfonate, etc., as well as combination thereof. Each of the above exemplified thiophene monomers may be prepared from thieno[3,4-b]-1,4-dioxin-2-methanol and a branched sultone compound in accordance with a known method (e.g., Journal of Electroanalytical Chemistry, 443, 217 to 226 (1998)).

“Extrinsically” conductive polymers may also be employed in the conductive polymer particles, which generally require the presence of a separate counterion that is not covalently bound to the polymer. One example of such an extrinsically conductive polymer is poly(3,4-ethylenedioxythiophene). The counterion may be a monomeric or polymeric anion that counteracts the charge of the conductive polymer. Polymeric anions can, for example, be anions derived from polymeric carboxylic acids (e.g., poly(meth)acrylic acids, such as poly-2-sulfoethyl(meth)acrylate or poly-3-propylsulfo(meth)acrylate; polymaleic acids; etc.); polymeric sulfonic acids (e.g., polystyrene sulfonic acids (“PSS”), polyvinyl sulfonic acids, etc.); and so forth, as well as salts thereof, such as an alkali metal, alkaline earth metal, transition metal, or ammonium salt thereof. Likewise, suitable monomeric anions may be derived from C₁ to C₂₀ alkane sulfonic acids (e.g., dodecane sulfonic acid); aliphatic fluorosulfonic acids (e.g., trifluoromethane sulfonic acid, perfluorobutane sulfonic acid, perfluorooctane sulfonic acid, trifluoromethanesulfonimide, etc.); aliphatic C₁ to C₂₀ carboxylic acids (e.g., 2-ethyl-hexylcarboxylic acid); aliphatic fluorocarboxylic acids (e.g., trifluoroacetic acid or perfluorooctanoic acid); aromatic sulfonic acids optionally substituted by C₁ to C₂₀ alkyl groups (e.g., benzene sulfonic acid, o-toluene sulfonic acid, p-toluene sulfonic acid, or dodecylbenzene sulfonic acid); cycloalkane sulfonic acids (e.g., camphor sulfonic acid); boronic compounds (e.g., tetrafluoroboric acid); phosphoric compounds (e.g., hexafluorophosphoric acid); and so forth, as well as salts thereof, such as an alkali metal, alkaline earth metal, transition metal, or ammonium salt thereof. Particularly suitable counteranions are polymeric anions, such as those derived from a polymeric carboxylic or sulfonic acid (e.g., polystyrene sulfonic acid (“PSS”)). The molecular weight of such compounds typically ranges from about 1,000 to about 2,000,000, and in some embodiments, from about 2,000 to about 500,000.

Whether intrinsically or extrinsically conductive, pre-polymerized conductive polymer particles may be applied to the anode body in a variety of forms, such as a solution, dispersion, etc. Intrinsically conductive polymers, for example, are typically applied in the form of a solution and extrinsically conductive polymers are typically applied in the form of a dispersion.

When a solution is employed, the concentration of the polymer may vary depending on the desired viscosity of and the particular manner in which the layer is to be applied to the anode. Typically, however, the polymer constitutes from about 0.1 to about 10 wt. %, in some embodiments from about 0.4 to about 5 wt. %, and in some embodiments, from about 0.5 to about 4 wt. % of the solution. Solvent(s) may likewise constitute from about 90 wt. % to about 99.9 wt. %, in some embodiments from about 95 wt. % to about 99.6 wt. %, and in some embodiments, from about 96 wt. % to about 99.5 wt. % of the solution. While other solvents may certainly be employed, it is generally desired that water is the primary solvent such that the solution is considered an “aqueous” solution. In most embodiments, for example, water constitutes at least about 50 wt. %, in some embodiments at least about 75 wt. %, and in some embodiments, from about 90 wt. % to 100 wt. % of the solvent(s) employed. When employed, a solution may be applied to the anode using any known technique, such as dipping, casting (e.g., curtain coating, spin coating, etc.), printing (e.g., gravure printing, offset printing, screen printing, etc.), and so forth. The resulting conductive polymer layer may be dried and/or washed after it is applied to the anode.

When a dispersion is employed, the conductive polymer particles typically have an average size (e.g., diameter) of from about 1 to about 100 nanometers, in some embodiments from about 2 to about 80 nanometers, and in some embodiments, from about 4 to about 50 nanometers. The diameter of the particles may be determined using known techniques, such as by ultracentrifuge, laser diffraction, etc. The shape of the particles may likewise vary. In one particular embodiment, for instance, the particles are spherical in shape. However, it should be understood that other shapes are also contemplated by the present invention, such as plates, rods, discs, bars, tubes, irregular shapes, etc. The concentration of the particles in the dispersion may vary depending on the desired viscosity of the dispersion and the particular manner in which the dispersion is to be applied to the capacitor element. Typically, however, the particles constitute from about 0.1 to about 10 wt. %, in some embodiments from about 0.4 to about 5 wt. %, and in some embodiments, from about 0.5 to about 4 wt. % of the dispersion.

The dispersion may also contain one or more binders to further enhance the adhesive nature of the polymeric layer and also increase the stability of the particles within the dispersion. The binders may be organic in nature, such as polyvinyl alcohols, polyvinyl pyrrolidones, polyvinyl chlorides, polyvinyl acetates, polyvinyl butyrates, polyacrylic acid esters, polyacrylic acid amides, polymethacrylic acid esters, polymethacrylic acid amides, polyacrylonitriles, styrene/acrylic acid ester, vinyl acetate/acrylic acid ester and ethylene/vinyl acetate copolymers, polybutadienes, polyisoprenes, polystyrenes, polyethers, polyesters, polycarbonates, polyurethanes, polyamides, polyimides, polysulfones, melamine formaldehyde resins, epoxide resins, silicone resins or celluloses. Crosslinking agents may also be employed to enhance the adhesion capacity of the binders.

Such crosslinking agents may include, for instance, melamine compounds, masked isocyanates or functional silanes, such as 3-glycidoxypropyltrialkoxysilane, tetraethoxysilane and tetraethoxysilane hydrolysate or crosslinkable polymers, such as polyurethanes, polyacrylates or polyolefins, and subsequent crosslinking.

Dispersion agents may also be employed to facilitate the ability to apply the layer to the anode. Suitable dispersion agents include solvents, such as aliphatic alcohols (e.g., methanol, ethanol, i-propanol and butanol), aliphatic ketones (e.g., acetone and methyl ethyl ketones), aliphatic carboxylic acid esters (e.g., ethyl acetate and butyl acetate), aromatic hydrocarbons (e.g., toluene and xylene), aliphatic hydrocarbons (e.g., hexane, heptane and cyclohexane), chlorinated hydrocarbons (e.g., dichloromethane and dichloroethane), aliphatic nitriles (e.g., acetonitrile), aliphatic sulfoxides and sulfones (e.g., dimethyl sulfoxide and sulfolane), aliphatic carboxylic acid amides (e.g., methylacetamide, dimethylacetamide and dimethylformamide), aliphatic and araliphatic ethers (e.g., diethylether and anisole), water, and mixtures of any of the foregoing solvents. A particularly suitable dispersion agent is water.

In addition to those mentioned above, still other ingredients may also be used in the dispersion. For example, conventional fillers may be used that have a size of from about 10 nanometers to about 100 micrometers, in some embodiments from about 50 nanometers to about 50 micrometers, and in some embodiments, from about 100 nanometers to about 30 micrometers. Examples of such fillers include calcium carbonate, silicates, silica, calcium or barium sulfate, aluminum hydroxide, glass fibers or bulbs, wood flour, cellulose powder carbon black, electrically conductive polymers, etc. The fillers may be introduced into the dispersion in powder form, but may also be present in another form, such as fibers.

Surface-active substances may also be employed in the dispersion, such as ionic or non-ionic surfactants. Furthermore, adhesives may be employed, such as organofunctional silanes or their hydrolysates, for example 3-glycidoxypropyltrialkoxysilane, 3-aminopropyl-triethoxysilane, 3-mercaptopropyl-trimethoxysilane, 3-metacryloxypropyltrimethoxysilane, vinyltrimethoxysilane or octyltriethoxysilane. The dispersion may also contain additives that increase conductivity, such as ether group-containing compounds (e.g., tetrahydrofuran), lactone group-containing compounds (e.g., γ-butyrolactone or γ-valerolactone), amide or lactam group-containing compounds (e.g., caprolactam, N-methylcaprolactam, N,N-dimethylacetamide, N-methylacetamide, N,N-dimethylformamide (DMF), N-methylformamide, N-methylformanilide, N-methylpyrrolidone (NMP), N-octylpyrrolidone, or pyrrolidone), sulfones and sulfoxides (e.g., sulfolane (tetramethylenesulfone) or dimethylsulfoxide (DMSO)), sugar or sugar derivatives (e.g., saccharose, glucose, fructose, or lactose), sugar alcohols (e.g., sorbitol or mannitol), furan derivatives (e.g., 2-furancarboxylic acid or 3-furancarboxylic acid), an alcohols (e.g., ethylene glycol, glycerol, di- or triethylene glycol).

The dispersion may be applied using a variety of known techniques, such as by spin coating, impregnation, pouring, dropwise application, injection, spraying, doctor blading, brushing, printing (e.g., ink-jet, screen, or pad printing), or dipping. The viscosity of the dispersion is typically from about 0.1 to about 100,000 mPas (measured at a shear rate of 100 s⁻¹), in some embodiments from about 1 to about 10,000 mPas, in some embodiments from about 10 to about 1,500 mPas, and in some embodiments, from about 100 to about 1000 mPas.

If desired, the solid electrolyte may be formed from multiple layers, such as inner and/or outer layers. The term “inner” in this context refers to one or more layers that overly the dielectric, whether directly or via another layer (e.g., pre-coat layer). The inner layer(s), for example, may contain an intrinsically conductive polymer and/or extrinsically conductive polymer as described above. In other embodiments, the inner layer(s) may contain a conductive polymer that is polymerized “in situ” using a polymerization process. In such an “in situ” process, as is well known in the art, an oxidative catalyst and precursor monomer may be applied either sequentially or together to initiate the polymerization reaction. One or multiple inner layers may be employed. For example, the solid electrolyte typically contains from 2 to 30, in some embodiments from 4 to 20, and in some embodiments, from about 5 to 15 inner layers (e.g., 10 layers). The solid electrolyte may contain only “inner layers” so that it is essentially formed from the same material. Nevertheless, in other embodiments, the solid electrolyte may also contain one or more optional “outer” conductive polymer layers that are formed from a different material than the inner layer(s) and overly the inner layer(s). For example, the inner layer(s) may be formed from an in-situ polymerized conductive polymer and/or solution of an intrinsically conductive polymer, while the outer layer(s) be formed from a dispersion of an extrinsically conductive polymer. In one particular embodiment, the outer layer(s) are formed primarily from such extrinsically conductive polymers in that they constitute about 50 wt. % or more, in some embodiments about 70 wt. % or more, and in some embodiments, about 90 wt. % or more (e.g., 100 wt. %) of a respective outer layer. One or multiple outer layers may be employed. For example, the solid electrolyte may contain from 2 to 30, in some embodiments from 4 to 20, and in some embodiments, from about 5 to 15 outer layers.

If desired, an external polymer coating may also be optionally employed that overlies the solid electrolyte. When employed, the external polymer coating typically contains one or more layers formed from pre-polymerized conductive polymer particles such as described above (e.g., dispersion of extrinsically conductive polymer particles). The external coating may be able to further penetrate into the edge region of the capacitor body to increase the adhesion to the dielectric and result in a more mechanically robust part, which may reduce equivalent series resistance and leakage current. Because it is generally intended to improve the degree of edge coverage rather to impregnate the interior of the anode body, the particles used in the external coating may have a larger size than those employed in the outer layers of the solid electrolyte. For example, the ratio of the average size of the particles employed in the external polymer coating to the average size of the particles employed in any dispersion of the solid electrolyte is typically from about 1.5 to about 30, in some embodiments from about 2 to about 20, and in some embodiments, from about 5 to about 15. For example, the particles employed in the dispersion of the external coating may have an average size of from about 80 to about 500 nanometers, in some embodiments from about 90 to about 250 nanometers, and in some embodiments, from about 100 to about 200 nanometers.

If desired, a crosslinking agent may also be employed in the external polymer coating to enhance the degree of adhesion to the solid electrolyte. Typically, the crosslinking agent is applied prior to application of the dispersion used in the external coating. Suitable crosslinking agents are described, for instance, in U.S. Patent Publication No. 2007/0064376 to Merker, et al. and include, for instance, amines (e.g., diamines, triamines, oligomer amines, polyamines, etc.); polyvalent metal cations, such as salts or compounds of Mg, Al, Ca, Fe, Cr, Mn, Ba, Ti, Co, Ni, Cu, Ru, Ce or Zn, phosphonium compounds, sulfonium compounds, etc. Particularly suitable examples include, for instance, 1,4-diaminocyclohexane, 1,4-bis(amino-methyl)cyclohexane, ethylenediamine, 1,6-hexanediamine, 1,7-heptanediamine, 1,8-octanediamine, 1,9-nonanediamine, 1,10-decanediamine, 1,12-dodecanediamine, N,N-dimethylethylenediamine, N,N,N′,N′-tetramethylethylenediamine, N,N,N′,N′-tetramethyl-1,4-butanediamine, etc., as well as mixtures thereof.

The crosslinking agent is typically applied from a solution or dispersion whose pH is from 1 to 10, in some embodiments from 2 to 7, in some embodiments, from 3 to 6, as determined at 25° C. Acidic compounds may be employed to help achieve the desired pH level. Examples of solvents or dispersants for the crosslinking agent include water or organic solvents, such as alcohols, ketones, carboxylic esters, etc. The crosslinking agent may be applied to the capacitor body by any known process, such as spin-coating, impregnation, casting, dropwise application, spray application, vapor deposition, sputtering, sublimation, knife-coating, painting or printing, for example inkjet, screen or pad printing. Once applied, the crosslinking agent may be dried prior to application of the polymer dispersion. This process may then be repeated until the desired thickness is achieved. For example, the total thickness of the entire external polymer coating, including the crosslinking agent and dispersion layers, may range from about 1 to about 50 μm, in some embodiments from about 2 to about 40 μm, and in some embodiments, from about 5 to about 20 μm.

### III. Other Components

If desired, the capacitor may also contain other layers and materials as is known in the art. For example, the capacitor may employ a cathode coating that overlies the solid electrolyte and other optional layers (e.g., external polymer coating). The cathode coating may contain a metal particle layer includes a plurality of conductive metal particles dispersed within a polymer matrix. The particles typically constitute from about 50 wt. % to about 99 wt. %, in some embodiments from about 60 wt. % to about 98 wt. %, and in some embodiments, from about 70 wt. % to about 95 wt. % of the layer, while the polymer matrix typically constitutes from about 1 wt. % to about 50 wt. %, in some embodiments from about 2 wt. % to about 40 wt. %, and in some embodiments, from about 5 wt. % to about 30 wt. % of the layer. The conductive metal particles may be formed from a variety of different metals, such as copper, nickel, silver, nickel, zinc, tin, lead, copper, aluminum, molybdenum, titanium, iron, zirconium, magnesium, etc., as well as alloys thereof. Silver is a particularly suitable conductive metal for use in the layer. If desired, the cathode coating may also contain a carbon layer (e.g., graphite) positioned between the solid electrolyte and the metal particle layer (e.g., silver) that can help further limit contact of the metal particle layer with the solid electrolyte.

A moisture barrier layer may also be employed overlies the solid electrolyte, optional external polymer coating, and optional cathode coating. The moisture barrier layer may be formed from a variety of different materials, such as a hydrophobic elastomer, e.g., silicones, fluoropolymers, etc. Silicone polymers are particularly suitable for use in the moisture barrier layer of the present invention. Such elastomers are typically derived from polyorganosiloxanes, such as those having the following general formula:

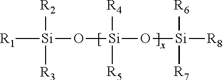

wherein,
x is an integer greater than 1; and
R₁, R₂, R₃, R₄, R₅, R₆, R₇, and R₈ are independently monovalent groups typically containing from 1 to about 20 carbon atoms, such as alkyl groups (e.g., methyl, ethyl, propyl, pentyl, octyl, undecyl, octadecyl, etc.); alkoxy groups (e.g., methoxy, ethoxy, propoxy, etc.); carboxyalkyl groups (e.g., acetyl); cycloalkyl groups (e.g., cyclohexyl); alkenyl groups (e.g., vinyl, allyl, butenyl, hexenyl, etc.); aryl groups (e.g., phenyl, tolyl, xylyl, benzyl, 2-phenylethyl, etc.); and halogenated hydrocarbon groups (e.g., 3,3,3-trifluoropropyl, 3-chloropropyl, dichlorophenyl, etc.). Examples of such polyorganosiloxanes may include, for instance, polydimethylsiloxane (“PDMS”), polymethylhydrogensiloxane, dimethyidiphenylpolysiloxane, dimethyl/methylphenylpolysiloxane, polymethylphenylsiloxane, methylphenyl/dimethylsiloxane, vinyldimethyl terminated polydimethylsiloxane, vinylmethyl/dimethylpolysiloxane, vinyldimethyl terminated vinylmethyl/dimethylpolysiloxane, divinylmethyl terminated polydimethylsiloxane, vinylphenylmethyl terminated polydimethylsiloxane, dimethylhydro terminated polydimethylsiloxane, methylhydro/dimethylpolysiloxane, methylhydro terminated methyloctylpolysiloxane, methylhydro/phenylmethyl polysiloxane, fluoro-modified polysiloxane, etc. To form an elastomer, the polyorganosiloxane may be crosslinked using any of a variety of known techniques, such as by catalyst curing (e.g., platinum catalysts), room temperature vulcanization, moisture curing, etc. Crosslinking agents may be employed, such as alkoxy silanes having the formula Si—OR, wherein R is H, alkyl (e.g., methyl), alkenyl, carboxyalkyl (e.g., acetyl), and so forth.

In addition to being hydrophobic, it is generally desired that the material used to form the moisture barrier layer has a relatively low modulus and a certain degree of flexibility, which can help absorb some of the thermal stresses caused by expansion of the casing and also allow it to be subjected to compressive forces. The flexibility of the material may be characterized by a corresponding low modulus of elasticity (“Young's modulus”), such as about 5,000 kilopascals (“kPa”) or less, in some embodiments from about 1 to about 2,000 kPa, and in some embodiments, from about 2 to about 500 kPa, measured at a temperature of about 25° C. The material also typically possesses a certain degree of strength that allows it to retain its shape even when subjected to compressive forces. For example, the material may possess a tensile strength of from about 1 to about 5,000 kPa, in some embodiments from about 10 to about 2,000 kPa, and in some embodiments, from about 50 to about 1,000 kPa, measured at a temperature of about 25° C. With the conditions noted above, the hydrophobic elastomer can even further enhance the ability of the capacitor to function under extreme conditions.

To help achieve the desired flexibility and strength properties, a non-conductive filler may be employed in the moisture barrier layer. When employed, such additives typically constitute from about 0.5 wt. % to about 30 wt. %, in some embodiments from about 1 wt. % to about 25 wt. %, and in some embodiments, from about 2 wt. % to about 20 wt. % of the moisture barrier layer. The silicone elastomer may constitute from about 70 wt. % to about 99.5 wt. %, in some embodiments from about 75 wt. % to about 99 wt. %, and in some embodiments, from about 80 wt. % to about 98 wt. % of the moisture barrier layer. One particular example of such a filler includes, for instance, silica. While most forms of silica contain a relatively hydrophilic surface due to the presence of silanol groups (Si—OH), the silica may optionally be surface treated so that its surface contains (CH₃)ₙ—Si— groups, wherein n is an integer of 1 to 3, which further enhances the hydrophobicity of the moisture barrier layer. The surface treatment agent may, for example, be an organosilicon compound monomer having a hydrolyzable group or a partial hydrolyzate thereof. Examples of such compounds may include organosilazanes, silane coupling agents such as described above, etc.

The moisture barrier layer may be applied to any surface of the capacitor to provide the desired properties. For example, the moisture barrier layer may be located on the top, bottom, and/or side surfaces of the capacitor. The moisture barrier layer may likewise be located on the front and/or rear surface of the capacitor. The moisture barrier layer may cover the entire area or only a portion of the area of the surface to which it is applied. In one embodiment, for example, the moisture barrier layer covers about 30% or more, in some embodiments about 40% or more, and in some embodiments, about 50% or more of a surface of the capacitor to which it is applied.

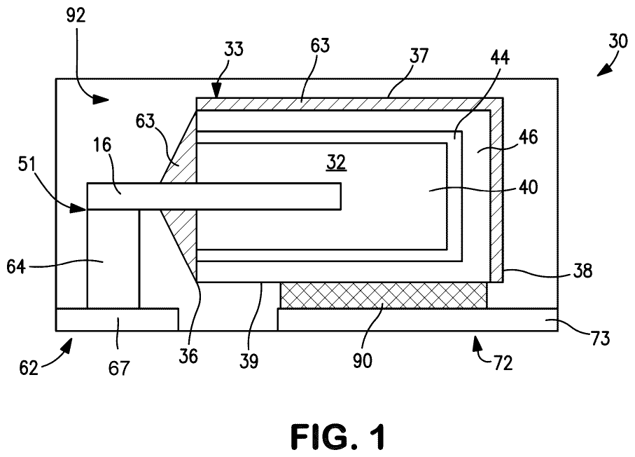

Referring to FIG. 1, for example, one embodiment of a capacitor 30 is shown that contains a capacitor element 33 having a generally rectangular shape and contains a front surface 36, rear surface 38, top surface 37, bottom surface 39, first side surface 32, and second side surface (not shown). In the illustrated embodiment, an anode lead 16 is embedded within an anode body 40 and extends from the front surface 36 of the capacitor element 33 in a longitudinal direction. The capacitor element 33 contains a dielectric (not shown) that overlies the anode body 40, solid electrolyte 44 that overlies that dielectric, and cathode coating 46 that overlies the solid electrolyte 44. As shown, the solid electrolyte 44 and cathode coating 46 are typically present at each surface of the capacitor 30 except for the front surface 36. Of course, it should be understood that such layers may be applied to any surface of the capacitor, and need not be applied in the manner illustrated.

The capacitor element 33 may also contain an optional moisture barrier layer 63 that includes a hydrophobic material. In this particular embodiment, the moisture barrier layer 63 overlies the solid electrolyte 44 at the rear surface 38, top surface 37, as well as the side surfaces (not shown). The moisture barrier layer 63 is also present at the front surface 36, although it may not necessarily overly the solid electrolyte at this surface as noted above. Of course, it should be understood that the moisture barrier layer 63 need not be located on the surfaces of the capacitor element 33 as shown in FIG. 1. In another embodiment, for example, the moisture barrier layer may be located only at the side surfaces of the capacitor element 33. Regardless of where it is located, the moisture barrier layer may cover any desired portion of the surface. For example, the moisture barrier layer may cover substantially all of the surfaces on which they are located, such as about 90% or more, and in some embodiments, about 95% or more. Once again, however, this is merely optional and the layer need not cover such a substantial portion of the surface.

The capacitor may also be provided with terminations, particularly when employed in surface mounting applications. For example, the capacitor may contain an anode termination to which an anode lead of the capacitor element is electrically connected and a cathode termination to which the cathode of the capacitor element is electrically connected. Any conductive material may be employed to form the terminations, such as a conductive metal (e.g., copper, nickel, silver, nickel, zinc, tin, palladium, lead, copper, aluminum, molybdenum, titanium, iron, zirconium, magnesium, and alloys thereof). Particularly suitable conductive metals include, for instance, copper, copper alloys (e.g., copper-zirconium, copper-magnesium, copper-zinc, or copper-iron), nickel, and nickel alloys (e.g., nickel-iron). The thickness of the terminations is generally selected to minimize the thickness of the capacitor. For instance, the thickness of the terminations may range from about 0.05 to about 1 millimeter, in some embodiments from about 0.05 to about 0.5 millimeters, and from about 0.07 to about 0.2 millimeters. One exemplary conductive material is a copper-iron alloy metal plate available from Wieland (Germany). If desired, the surface of the terminations may be electroplated with nickel, silver, gold, tin, etc. as is known in the art to ensure that the final part is mountable to the circuit board. In one particular embodiment, both surfaces of the terminations are plated with nickel and silver flashes, respectively, while the mounting surface is also plated with a tin solder layer.

The terminations may be connected using any technique known in the art. In one embodiment, for example, a lead frame may be provided that defines the cathode termination and anode termination. To attach the capacitor element to the lead frame, a conductive adhesive may initially be applied to a surface of the cathode termination. The conductive adhesive may include, for instance, conductive metal particles contained with a resin composition. The metal particles may be silver, copper, gold, platinum, nickel, zinc, bismuth, etc. The resin composition may include a thermoset resin (e.g., epoxy resin), curing agent (e.g., acid anhydride), and compound (e.g., silane compounds). Suitable conductive adhesives may be described in U.S. Patent Application Publication No. 2006/0038304 to Osako, et al. Any of a variety of techniques may be used to apply the conductive adhesive to the cathode termination. Printing techniques, for instance, may be employed due to their practical and cost-saving benefits. The anode lead may also be electrically connected to the anode termination using any technique known in the art, such as mechanical welding, laser welding, conductive adhesives, etc. Upon electrically connecting the anode lead to the anode termination, the conductive adhesive may then be cured to ensure that the electrolytic capacitor element is adequately adhered to the cathode termination.

Referring again to FIG. 1, for example, the capacitor 30 is shown as including an anode termination 62 and a cathode termination 72 in electrical connection with the capacitor element 33. Although it may be in electrical contact with any of the surfaces of the capacitor element 33, the cathode termination 72 in the illustrated embodiment is in electrical contact with the lower surface 39 via a conductive adhesive 90. More specifically, the cathode termination 72 contains a first component 73 that is in electrical contact and generally parallel with the lower surface 39 of the capacitor element 33. The anode termination 62 likewise contains a first component 67 positioned substantially perpendicular to a second component 64. The first component 67 is in electrical contact and generally parallel with the lower surface 39 of the capacitor element 33. The second component 64 contains a region 51 that carries an anode lead 16. Although not depicted in FIG. 1, the region 51 may possess a “U-shape” to further enhance surface contact and mechanical stability of the lead 16.

The terminations may be connected to the capacitor element using any technique known in the art. In one embodiment, for example, a lead frame may be provided that defines the cathode termination 72 and anode termination 62. To attach the electrolytic capacitor element 33 to the lead frame, the conductive adhesive 90 may initially be applied to a surface of the cathode termination 72. The conductive adhesive 90 may include, for instance, conductive metal particles contained with a resin composition. The metal particles may be silver, copper, gold, platinum, nickel, zinc, bismuth, etc. The resin composition may include a thermoset resin (e.g., epoxy resin), curing agent (e.g., acid anhydride), and coupling agent (e.g., silane coupling agents). Suitable conductive adhesives may be described in U.S. Patent Publication No. 2006/0038304 to Osako, et al. Any of a variety of techniques may be used to apply the conductive adhesive to the cathode termination 72. Printing techniques, for instance, may be employed due to their practical and cost-saving benefits.

A variety of methods may generally be employed to attach the terminations to the capacitor. In one embodiment, for example, the second component 64 of the anode termination 62 is initially bent upward to the position shown in FIG. 1. Thereafter, the capacitor element 33 is positioned on the cathode termination 72 so that its lower surface 39 contacts the adhesive 90 and the anode lead 16 is received by the region 51. If desired, an insulating material (not shown), such as a plastic pad or tape, may be positioned between the lower surface 39 of the capacitor element 33 and the first component 67 of the anode termination 62 to electrically isolate the anode and cathode terminations.

The anode lead 16 is then electrically connected to the region 51 using any technique known in the art, such as mechanical welding, laser welding, conductive adhesives, etc. For example, the anode lead 16 may be welded to the anode termination 62 using a laser. Lasers generally contain resonators that include a laser medium capable of releasing photons by stimulated emission and an energy source that excites the elements of the laser medium. One type of suitable laser is one in which the laser medium consist of an aluminum and yttrium garnet (YAG), doped with neodymium (Nd). The excited particles are neodymium ions Nd³⁺. The energy source may provide continuous energy to the laser medium to emit a continuous laser beam or energy discharges to emit a pulsed laser beam. Upon electrically connecting the anode lead 16 to the anode termination 62, the conductive adhesive may then be cured. For example, a heat press may be used to apply heat and pressure to ensure that the electrolytic capacitor element 33 is adequately adhered to the cathode termination 72 by the adhesive.

The capacitor element may also be incorporated within a housing. In certain embodiments, for instance, the capacitor element may be enclosed within a case, which may then be filled with a resinous material, such as a thermoset resin that can be cured to form a hardened housing. Examples of such resins include, for instance, epoxy resins, polyimide resins, melamine resins, urea-formaldehyde resins, polyurethane resins, phenolic resins, polyester resins, etc. Epoxy resins are also particularly suitable. Still other additives may also be employed, such as photoinitiators, viscosity modifiers, suspension aiding agents, pigments, stress reducing agents, non-conductive fillers, stabilizers, etc. For example, the non-conductive fillers may include inorganic oxide particles, such as silica, alumina, zirconia, magnesium oxide, iron oxide, copper oxide, zeolites, silicates, clays (e.g., smectite clay), etc., as well as composites (e.g., alumina-coated silica particles) and mixtures thereof. The resinous material may surround and encapsulate the capacitor element so that at least a portion of the anode and cathode terminations are exposed for mounting onto a circuit board. When encapsulated in this manner, the capacitor element and resinous material form an integral capacitor. As shown in FIG. 1, for instance, the capacitor element 33 is encapsulated within a housing 92 so that a portion of the anode termination 62 and a portion of the cathode termination 72 are exposed.

Of course, in alternative embodiments, it may be desirable to enclose the capacitor element within a housing that remains separate and distinct. In this manner, the atmosphere of the housing can be selectively controlled so that it is dry, which limits the degree of moisture that can contact the capacitor element. For example, the moisture content of the atmosphere (expressed in terms of relative humidity) may be about 10% or less, in some embodiments about 5% or less, in some embodiments about 3% or less, and in some embodiments, from about 0.001 to about 1%. For example, the atmosphere may be gaseous and contain at least one inert gas, such as nitrogen, helium, argon, xenon, neon, krypton, radon, and so forth, as well as mixtures thereof. Typically, inert gases constitute the majority of the atmosphere within the housing, such as from about 50 wt. % to 100 wt. %, in some embodiments from about 75 wt. % to 100 wt. %, and in some embodiments, from about 90 wt. % to about 99 wt. % of the atmosphere. If desired, a relatively small amount of non-inert gases may also be employed, such as carbon dioxide, oxygen, water vapor, etc. In such cases, however, the non-inert gases typically constitute 15 wt. % or less, in some embodiments 10 wt. % or less, in some embodiments about 5 wt. % or less, in some embodiments about 1 wt. % or less, and in some embodiments, from about 0.01 wt. % to about 1 wt. % of the atmosphere within the housing.

Any of a variety of different materials may be used to form the housing, such as metals, plastics, ceramics, and so forth. In one embodiment, for example, the housing includes one or more layers of a metal, such as tantalum, niobium, aluminum, nickel, hafnium, titanium, copper, silver, steel (e.g., stainless), alloys thereof (e.g., electrically conductive oxides), composites thereof (e.g., metal coated with electrically conductive oxide), and so forth. In another embodiment, the housing may include one or more layers of a ceramic material, such as aluminum nitride, aluminum oxide, silicon oxide, magnesium oxide, calcium oxide, glass, etc., as well as combinations thereof.

The present invention may be better understood by reference to the following examples and test procedures.

### Test Procedures

### Anode Porosity

The anode porosity was determined after anodic oxidation using a mercury intrusion porosimeter (Micromeritics Auto Pore IV 9510).

### Capacitance

Capacitance may generally be measured using a Keithley 3330 Precision LCZ meter with Kelvin Leads with 2.2 volt DC bias and a 0.5 volt peak to peak sinusoidal signal. The operating frequency may be 120 Hz and the temperature may be 23° C.±2° C.

### Wet Capacitance

The “wet capacitance” refers to the capacitance of the part after formation of the dielectric but before application of the solid electrolyte, graphite, and silver layers and it is measured in 14% nitric acid in reference to a 1 mF tantalum cathode with 10 volt DC bias and a 0.5 volt peak to peak sinusoidal signal after 30 seconds of electrolyte soaking. The “volumetric wet capacitance” is determined by dividing the wet capacitance by the total anode pellet volume (determined after sintering). For a sintered pellet in the shape of a rectangular prism, for example, the volume is determined by multiplying the length, width, and heigh of the pellet.

### Breakdown Voltage (“BDV”)

The breakdown voltage may be determined using Keithley 2400 SourceMeter at the temperature 23° C.±2° C. An individual capacitor is charged with constant current determined by the equation:

$$Current ( A ) = Nominal Capacitance ( F ) \times dU / dt ,$$

where dU/dt represents the theoretical voltage slope typically set to 10 V/s. For example, the applied current may be set to 470 μA for unit with nominal capacitance 47 μF and theoretical voltage slope 10 V/s. The voltage is measured during charging and when the applied voltage decreases more than 10% from the highest achieved value, the maximum achieved voltage value is recorded as the “breakdown voltage” of each unit. At least ten (10) units are tested from one sample group and the minimum value is recorded as the “breakdown voltage.”

### Dielectric Thickness

The “dielectric thickness” (mm) may be measured using Zeiss Sigma FESEM at 20,000× to 50,000× magnification, wherein the sample is prepared by cutting a finished part in plane perpendicular to the longest dimension of the finished part, and the thickness is measured at sites where the cut is perpendicular through the dielectric layer. The average thickness value is recorded as the “dielectric thickness.”

### Dielectric Strength

The “dielectric strength” (V/mm) of a capacitor may be determined by dividing the breakdown voltage (minimum value recorded) by the dielectric thickness (average value recorded).

### COMPARATIVE EXAMPLE 1

40,000 μFV/g tantalum powder was used to form anode samples. Each anode sample was pressed into pellets having a density of 5.3 g/cm³ and the shape of a rectangular prism having an initial volume of 0.1591 cm³ (0.52 cm×0.085 cm×0.36 cm. The pellets were then sintered at 1410° C. such that the total anode pellet volume (determined after sintering) was 0.01496 cm³. The sintered pellets were anodized at a forming voltage of 67V in a water/phosphoric acid electrolyte at a temperature of 85° C. to form the dielectric. The pellets were anodized again to 130 volts in a water/boric acid/disodium tetraborate with a conductivity of 2.0 mS at a temperature of 30° C. for 10 seconds to form a thicker oxide layer built up on the outside. The resulting specific charge was 45,700 μF*V/g, wet capacitance was 56.6 μF, volumetric wet capacitance 3,783 μF/cm³, D50 pore size was 500 nm, D80 pore size was 285 nm, and D90 pore size was 200 nm.

### EXAMPLES 1-8

Eight (8) samples were formed in the manner described in Comparative Example 1, except that a tantalum powder that had a certain controlled pore size distribution. The sintering temperature was modified for each sample to achieve a similar level of volumetric shrinkage (i.e., 9%). The resulting sintering temperature, D50, D80, and D90 pore sizes, specific charge, and volumetric capacitance for the samples are set forth in the table below.

| | | D50 | D80 | D90 | | Pellet | |
|---|---|---|---|---|---|---|---|
| | Sintering | Pore | Pore | Pore | Specific | Volume After | Wet |
| | Temperature | Size | Size | Size | Charge | Sintering | Capacitance |
| Example | (° C.) | (nm) | (nm) | (nm) | (μF/g) | (cm³) | (μF) |
| 1 | 1365 | 256 | 165 | 135 | 51,300 | 0.01416 | 62.5 |
| 2 | 1365 | 317 | 210 | 165 | 52,400 | 0.01528 | 64.1 |
| 3 | 1365 | 315 | 186 | 151 | 51,000 | 0.01428 | 63.8 |
| 4 | 1380 | 464 | 220 | 170 | 50,400 | 0.01471 | 62.4 |
| 5 | 1380 | 317 | 186 | 151 | 50,000 | 0.01433 | 62.0 |
| 6 | 1380 | 286 | 186 | 151 | 50,500 | 0.01422 | 61.8 |
| 7 | 1365 | 316 | 205 | 167 | 52,000 | 0.01436 | 63.5 |
| 8 | 1365 | 286 | 186 | 136 | 52,000 | 0.01494 | 64.1 |

Capacitors were thereafter formed from the samples above. Upon anodization, four pre-coat layers of organometallic compound were used that contained a solution of (3-aminopropyl)trimethoxysilane in ethanol (1.0%). A conductive polymer coating was formed by dipping the anodes into a solution of poly(4-(2,3-dihydrothieno-[3,4-b][1,4]dioxin-2-ylmethoxy)-1-butane-sulphonic acid having a solids content of 2.0% (Clevios™ K, Heraeus). Upon coating, the parts were dried at 125° C. for 15 minutes. This process was repeated 2 times. Thereafter, the parts were dipped into a dispersed poly(3,4-ethylenedioxythiophene) having a solids content 1.1% and viscosity 20 mPa·s (Clevios™ K, Heraeus). Upon coating, the parts were dried at 125° C. for 15 minutes. This process was repeated 8 times. Thereafter, the parts were dipped into a dispersed poly(3,4-ethylenedioxythiophene) having a solids content 2.0% and viscosity 20 mPa·s (Clevios™ K, Heraeus). Upon coating, the parts were dried at 125° C. for 15 minutes. This process was repeated 3 times. Thereafter, the parts were dipped into a dispersed poly(3,4-ethylenedioxythiophene) having a solids content of 2% and viscosity 160 mPa·s (Clevios™ K, Heraeus). Upon coating, the parts were dried at 125° C. for 15 minutes. This process was repeated 14 times. The parts were then dipped into a graphite dispersion and dried. Finally, the parts were dipped into a silver dispersion and dried. Multiple parts (900) of 56 μF/35V capacitors were made in this manner and encapsulated in a silica resin.

Various electrical properties of the anodes and finished capacitors of the Examples and Comparative Example 1 were then measured. The results are set forth below.

| | Volumetric | | | | Average | |
|---|---|---|---|---|---|---|
| | Wet | | | | Dielectric | Dielectric |
| | Capacitance | Minimum | Average | Maximum | Thickness | Strength |
| Example | (μF/cm³) | BDV (V) | BDV (V) | BDV (V) | (nm) | (V/nm) |
| Comparative Ex. 1 | 3,783 | 85 | 89 | 97 | 113.1 | 0.75 |
| 1 | 4,414 | 83 | 87 | 92 | 113.1 | 0.73 |
| 2 | 4,196 | 72 | 83 | 88 | 113.1 | 0.64 |
| 3 | 4,468 | 84 | 89 | 93 | 113.1 | 0.74 |
| 4 | 4,241 | 84 | 88 | 90 | 113.1 | 0.74 |
| 5 | 4,326 | 70 | 84 | 91 | 113.1 | 0.62 |
| 6 | 4,345 | 68 | 82 | 93 | 113.1 | 0.60 |
| 7 | 4,423 | 74 | 84 | 94 | 113.1 | 0.65 |
| 8 | 4,291 | 81 | 84 | 91 | 113.1 | 0.72 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A solid electrolytic capacitor comprising:
a porous anode formed from a sintered valve metal powder that is anodically oxidized to form a dielectric layer thereon having a dielectric thickness of about 70 nm or more, wherein the porous anode has a pore size distribution in which the pores have a size of from about 165 to about 270 nm at a pore volume corresponding to at least 80% of the total pore volume and exhibits a volumetric wet capacitance of about 3,900 μF/cm³ or more; and
a solid electrolyte overlying the dielectric, wherein the solid electrolyte contains conductive polymer particles that are disposed within the pores of the porous anode;
wherein the solid electrolytic capacitor exhibits a dielectric strength of about 0.6 V/nm or more.

2. The solid electrolytic capacitor of claim 1, wherein the porous anode has a pore size distribution in which the pores have a size of from about 170 nm to about 260 nm at a pore volume corresponding to at least 80% of the total pore volume.

3. The solid electrolytic capacitor of claim 1, wherein the porous anode has a pore size distribution in which the pores have a size of from about 180 nm to about 250 nm at a pore volume corresponding to at least 80% of the total pore volume.

4. The solid electrolytic capacitor of claim 1, wherein the porous anode has a pore size distribution in which the pores have a size of from about 130 to about 190 nm at a pore volume corresponding to at least 90% of the total pore volume.

5. The solid electrolytic capacitor of claim 1, wherein the porous anode has a pore size distribution in which the pores have a size of from about 100 to about 475 nm at a pore volume corresponding to at least 50% of the total pore volume.

6. The solid electrolytic capacitor of claim 1, wherein the dielectric thickness is from about 100 nm to about 200 nm.

7. The solid electrolytic capacitor of claim 1, wherein the capacitor exhibits a dielectric strength of about 0.7 V/nm or more.

8. The solid electrolytic capacitor of claim 1, wherein the capacitor exhibits a breakdown voltage of about 50 V or more.

9. The solid electrolytic capacitor of claim 1, wherein the capacitor exhibits a breakdown voltage of about 70 V or more.

10. The solid electrolytic capacitor of claim 1, wherein the anode body includes tantalum and the dielectric includes tantalum pentoxide.

11. The solid electrolytic capacitor of claim 1, wherein the conductive polymer particles contain a thiophene polymer.

12. The solid electrolytic capacitor of claim 1, wherein the conductive polymer particles contain an intrinsically conductive thiophene polymer containing repeating units of the following formula: 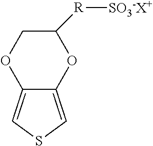
wherein,
R is (CH₂)ₐ—O—(CH₂)_{b}-L, where L is a bond or HC([CH₂]_{c}H);
a is from 0 to 10;
b is from 1 to 18;
c is from 0 to 10; and
X is a cation.

13. The solid electrolytic capacitor of claim 1, wherein the conductive polymer particles contain an intrinsically conductive thiophene polymer containing repeating units of the following formula: 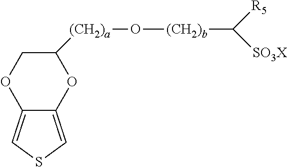
wherein,
a is from 0 to 10;
b is from 1 to 18;
R₅ is an optionally substituted C₁-C₆ linear or branched alkyl group or a halogen atom;
X is a hydrogen atom, an alkali metal, NH(R¹)₃, or HNC₅H₅, wherein R¹ is each independently a hydrogen atom or an optionally substituted C₁-C₆ alkyl group.

14. The solid electrolytic capacitor of claim 1, wherein the conductive polymer particles contain poly(3,4-ethylenedioxythiophene) and a polymeric counterion.

15. The solid electrolytic capacitor of claim 1, further comprising:
an anode termination that is in electrical connection with the anode;
a cathode termination that is in electrical connection with the solid electrolyte; and
a housing that encloses the capacitor element and leaves exposed at least a portion of the anode termination and the cathode termination.

16. The solid electrolytic capacitor of claim 1, wherein the capacitor further comprises a pre-coat layer that is positioned between the dielectric and the solid electrolyte.

17. The solid electrolytic capacitor of claim 1, wherein the capacitor further comprises a cathode coating that overlies the solid electrolyte.

18. The solid electrolytic capacitor of claim 17, wherein the capacitor further comprises a moisture barrier that overlies the cathode coating and the solid electrolyte.
